(19) United States
(12) Patent Application Publication
(10) Pub. No.: US 2014/0379468 A1
(43) Pub. Date: Dec. 25, 2014

(54) METHODS, DEVICES AND NON-TRANSITORY COMPUTER-READABLE MEDIA FOR AUGMENTED REALITY SHOPPING

(71) Applicant: Infosys Limited, Bangalore (IN)

(72) Inventors: Jai Ganesh, Bangalore (IN); Saikat Chatterjee, Bangalore (IN); Tarun Prakash Sharma, Dehradun (IN); Manmohan Nair, Trivandrum (IN)

(73) Assignee: Infosys Limited, Bangalore (IN)

(21) Appl. No.: 14/220,987

(22) Filed: Mar. 20, 2014

(30) Foreign Application Priority Data
Jun. 24, 2013 (IN) 2719/CHE/2013

(51) Int. Cl. G06Q 30/06; G06Q 30/02

(52) U.S. Cl. CPC G06Q 30/0623; G06Q 30/0255
USPC 705/14.53

(57) ABSTRACT

The present invention provides a method and system for augmented reality shopping. A visual code of the product can be scanned by a portable device. A set of information can be extracted by a web server, whereby the set of information can include a set of providers, offering the product within a location of the portable device. A provider of the product can be selected by a comparing module, where the provider offers a best price of the product. The product as offered by the selected provider can be added to a shopping cart.

This application claims the benefit of Indian Patent Application Filing No. 2719/CHE/2013, filed Jun. 24, 2013, which is hereby incorporated by reference in its entirety.

### FIELD

The present invention relates generally to a method and system for providing an immersive shopping experience for retail shoppers. More specifically, the present invention relates to a method and system for shopping in an augmented reality.

### BACKGROUND

Current systems and methods provide a retail shopper with a non-immersive shopping experience. Existing products lack the combination of augmented reality with location and social networking experience. A retail shopping experience is usually enhanced by augmented reality combined with location information. Augmented Reality (AR) is a technology that superimposes a current view on a display of a user device with computer generated information. A system that augments the current view of a shopping item, with computer generated information including location based information and feedback from social networks, shall improve a purchase decision of the retail shopper, as the retail shopper can make a more informed product purchase decision, as enriched by the feedbacks received from other users of the product. As a result, the retail shopper can make comparisons based on product parameters as well as location and peer-to-peer review.

There is a need for a platform that can enable the retailer to receive, location based information and key social network inputs to obtain an immersive shopping experience. The alternate system must be accessible from a portable user device such as a Mobile device, a PC, an in-store kiosk, a television, and a head mounted display. Thus a method for providing an augmented reality along with location based information and social networking feedback to the retail shopper is proposed.

### SUMMARY

The present invention provides a method and system for augmented reality shopping. In accordance with a disclosed embodiment, the method may include scanning a visual code of a product by a portable device. Further, a set of information of the product can be extracted from a catalog engine, by a web server. The set of information may include a set of providers offering the product from within a location of the portable device. Selecting, by a comparing module, a provider of the product, whereby the provider offers a best price of the product. Finally, the product as offered by the selected provider maybe added to the shopping cart.

In an additional embodiment, a system for augmented reality shopping is disclosed. The system comprises a portable device, configured to, scan a visual code of the product, and add the product to a shopping cart. Further, the system includes a web server, configured to extract a set of information of the product from a catalog engine, where the set of information includes set of providers, offering the product within a location of the portable device. The system further includes a comparator module, configured to select a provider of the product, whereby the provider offers a best price of the product.

These and other features, aspects, and advantages of the present invention will be better understood with reference to the following description and claims.

### BRIEF DESCRIPTION OF THE DRAWINGS

FIG. 1 is a flowchart illustrating an embodiment of a method for augmented reality shopping;

FIG. 2 is a flowchart illustrating an alternate embodiment of a method for augmented reality shopping;

FIGS. 3a and 3b is a flowchart illustrating an alternate embodiment of a method for augmented reality shopping;

FIG. 4 shows an exemplary system for performing augmented reality shopping; and

FIG. 5 illustrates a generalized example of a computing environment.

While systems and methods are described herein by way of example and embodiments, those skilled in the art recognize that systems and methods for electronic financial transfers are not limited to the embodiments or drawings described. It should be understood that the drawings and description are not intended to be limiting to the particular form disclosed. Rather, the intention is to cover all modifications, equivalents and alternatives falling within the spirit and scope of the appended claims. Any headings used herein are for organizational purposes only and are not meant to limit the scope of the description or the claims. As used herein, the word “may” is used in a permissive sense (i.e., meaning having the potential to) rather than the mandatory sense (i.e., meaning must). Similarly, the words “include”, “including”, and “includes” mean including, but not limited to.

### DETAILED DESCRIPTION

Disclosed embodiments provide computer-implemented methods, systems, and computer-program products for providing an immersive shopping experience to a retail user. More specifically the methods, and systems disclosed provide a framework for shopping in an augmented reality (AR). AR systems are defined by their ability to spatially integrate virtual objects into the physical world in real-time, immersing the user in an information-rich, interactive environment. The disclosed systems and methods provide an immersive shopping experience to the retail user by combining location based information, and a set of social networking inputs in an augmented reality environment. As a result, the retail user can make an informed product purchase decision, supported by feedbacks received from other users. Such systems and methods enable real-time comparisons between existing deals on products, and reduce the time required while shopping. The disclosed system can be deployed over a web hosting service or a cloud service and can be accessed via a Mobile device, a personal computer, an in-store kiosk, a television, a head mounted displays and similar devices.

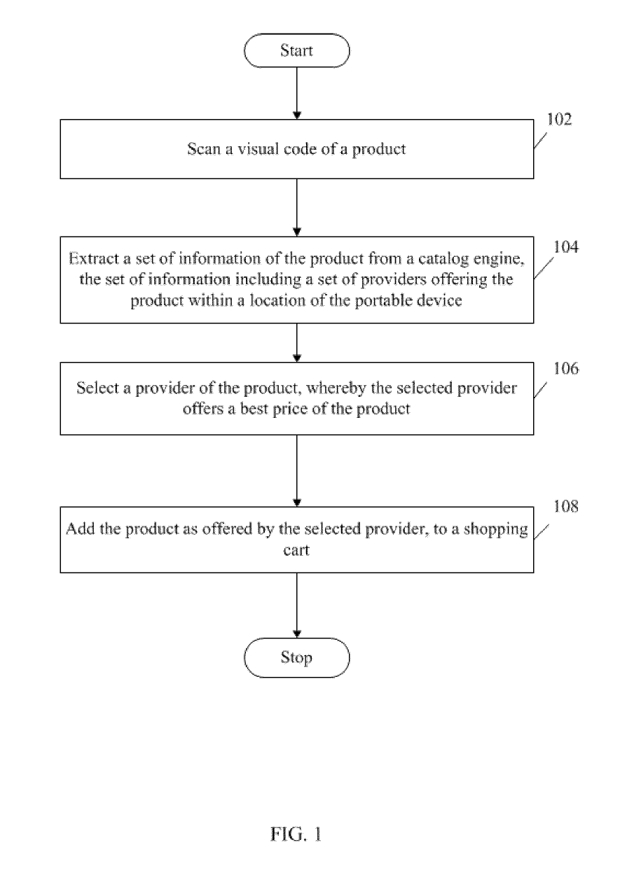

FIG. 1 is a flowchart that illustrates a method performed for augmented reality shopping in accordance with an embodiment of the present invention. A visual code of the product can be scanned by a portable device of a user involved in the augmented reality shopping, at step 102. Further, at step 104, a set of information of the product can be extracted from a catalog engine; the set of information may include a set of providers offering the product within a location of the portable device. At step 106, a provider of the product can be selected by a comparator module, where the provider offers a best price of the product. Finally, at step 108, the product as offered by the selected provider, can be added to a shopping cart.

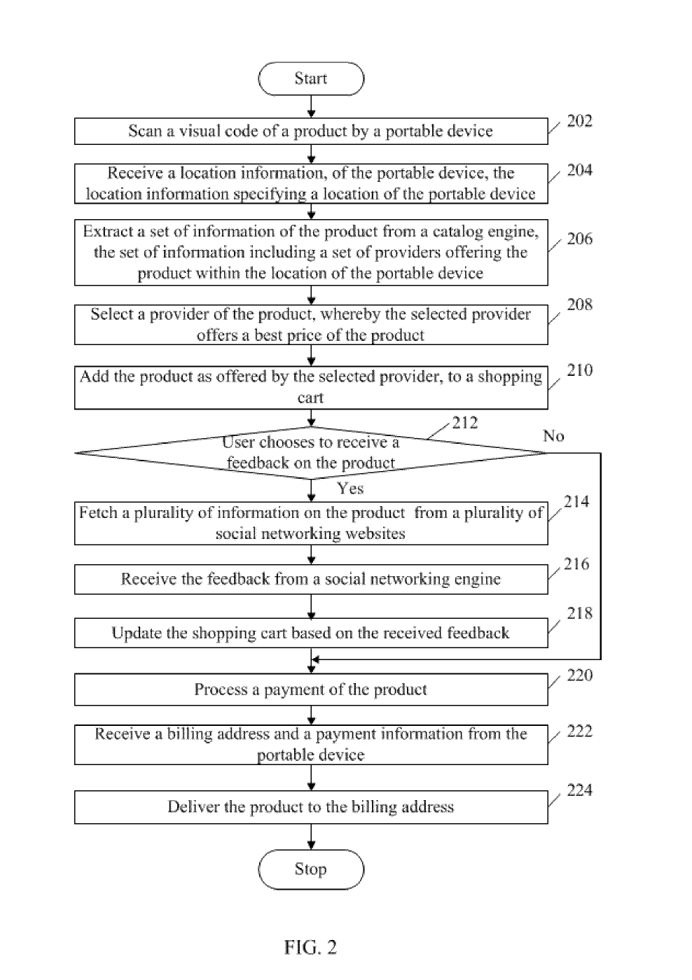

FIG. 2 illustrates an alternate embodiment of a method of practicing the present invention. At step 202, a visual code of the product can be scanned by a portable device, of a user involved in the augmented reality shopping. The visual code can be transmitted by the portable device, to a web server, where, the visual code is mapped to a set of details of the product, such as a provider of the product. At step 202, a location information of the portable device, can be received, where the location information specifies a location of the portable device. Further, at step 206, a provider of the product can be selected, where the provider offers a best price of the product. At step 210, the product as offered by the selected provider, cam be added to a shopping cart. Nest at step 212, a user may choose to receive a feedback on the product. At step 214, a plurality of information on the product can be fetched, by a social networking engine, from a plurality of social networking websites. At step 216, a feedback on the product can be received by the fetched plurality of information, by the social networking engine. At step 218, the shopping cart can be updated based on the feedback. A product may be added, and alternatively deleted from the shopping cart in an event the feedback on the product is favorable or unfavorable respectively. In an event, the user, chooses not to receive the feedback, the user is directed to a payment process. At step 220, a payment of the product is processes. At step 222, a billing address and a payment information can be received form the portable device. And at step 224, the product can be delivered at the billing address.

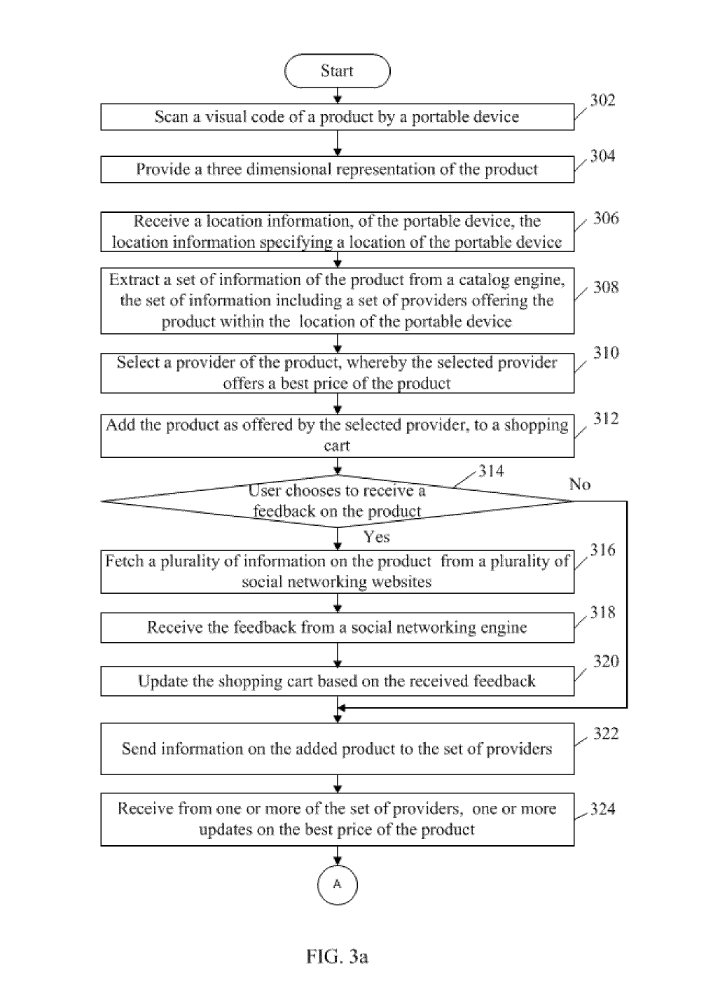

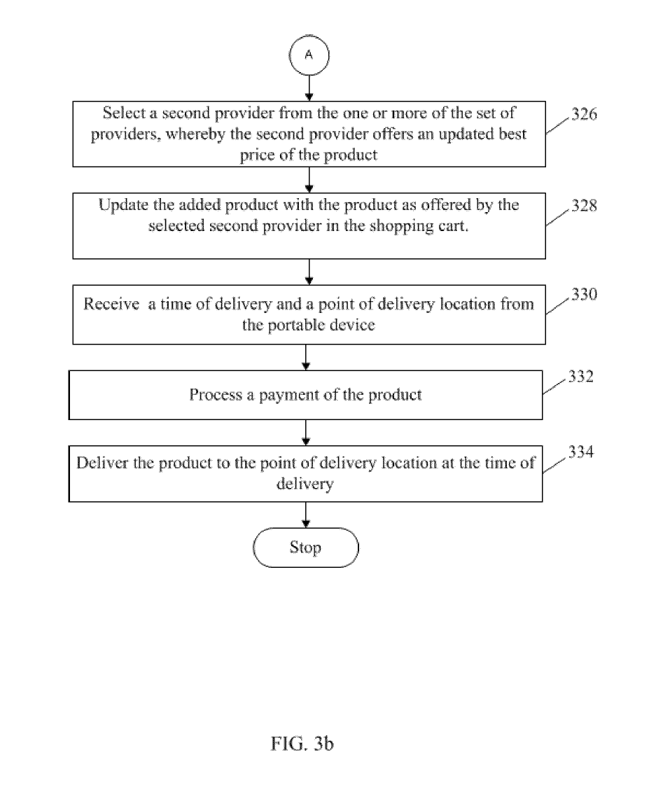

FIGS. 3a and 3b illustrate an alternate embodiment of a method of providing augmented reality shopping. At step 302, a visual code, of the product can be scanned, by a portable device. At step 304, a three dimensional representation of the product, can be provided, by a web server in communication with an augmented reality model library. The augmented reality model library, can be an open standard interface, as available in prior art, configured to provide an augmented reality delivered on the portable device. At step 306, a location information of the portable device can be received, the location information can include a location co-ordinates of the portable device. Further, at step 308, a set of information of the product can be extracted, from a catalog engine, and the set of information, may include a set of providers offering the product within the location of the portable device. Further, at step 310, a provider of the product, may be selected where the selected provider offers a best price of the product. At 312, the user may choose to add the product as offered by the selected provider to a shopping cart. At step 314, in an event the user chooses to receive feedback reviews on the product, a plurality of information on the product can be fetched from a plurality of social networking websites at step 316. Further, the feedback can be received by a social networking engine, at step 318, and provided to the web server. The feedback shall be provided to the user, on the portable device. Based on the received feedback the user may choose to update the shopping cart at step 320. At step 322, information on the added product in the shopping cart may be transmitted to the set of providers of the product. One or more updates on the best price of the product can be received from one or more of the set of providers, in a spirit of competing with the added product at step 324. At step 326, a second provider can be selected form the one or more of the set of providers, where the second provider offers an updated best price of the product. Further, at step 328, the added product can be updated with the product as offered by the selected second provider in the shopping cart. For instantaneous delivery of the product, a time of delivery and a point of delivery location of the product may be received from the portable device, at step 330. Further, at step 332, a payment of the product can be processed. Finally at step 334, the product can be delivered at the point of delivery at the time of delivery.

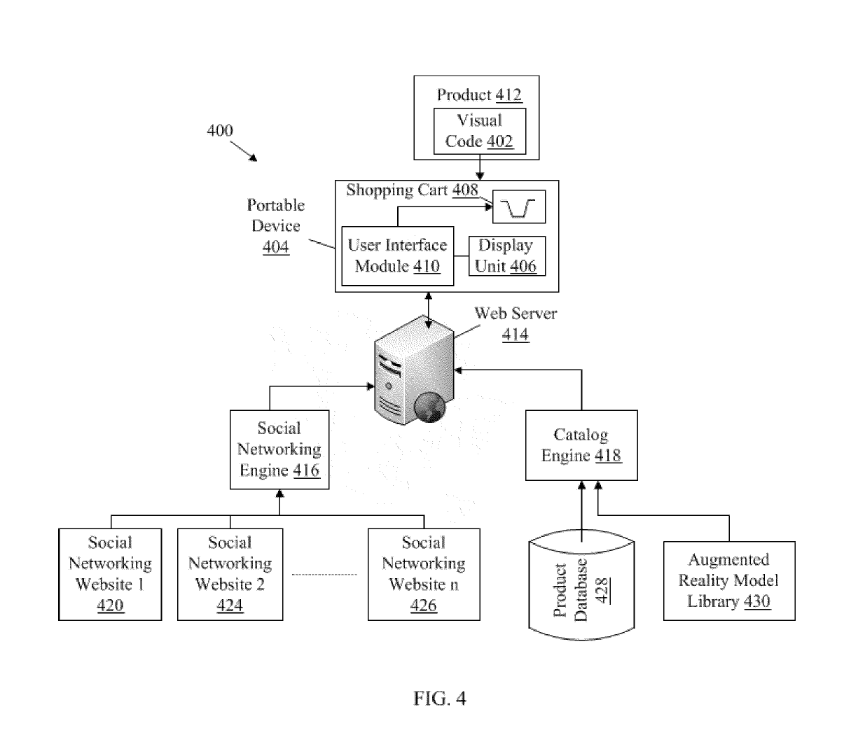

FIG. 4 illustrates an exemplary system 400 in which various embodiments of the invention can be practiced. The exemplary system 400 includes a portable device 404, a web server 414, a social networking engine 416, a plurality of social networking websites 420, 424 and 426, a catalog engine 418, a product database 428, and an augmented reality model library 430. The portable device 404 includes a user interface module 410, and a display unit 406. A product 412 is illustrated as an instance for describing a working of the system 400, for shopping the product 412, in an augmented reality.

The product 412, in the instance can be a product image, a product, a banner of a product, a hoarding including a deal on the product, and the like. A visual code 402, on the product 412, is usually scanned by the portable device 404, for procuring information on the product 412. The visual code 402 can be a bar code, a Quick Response (QR) code, and any such visual sign holding the information on the product 412 such as a make of the product 412, a serial number, and expiry data, and a date of manufacture of the product 412.

The portable device 404, can be any electronic device capable of scanning images by an input module such as a camera. Instances of the portable device 404, may include a camera enabled mobile device, a head mounted display, a television, a personal computer, a laptop, and a PDA. On scanning the visual code 402, a user involved in shopping of the product 412, can access the information on the product 412, via the user interface module 410. A three-dimensional representation of the product 412, can be accessed by the augmented reality model library 430, via a connection through the web server 414, and the catalog engine 418. The augmented reality model library 430, is an open standard library interface, that can capture the users input and provide a desired image and view of the product 412. The user interface module 410 of the portable device 404, can be configured to display the three-dimensional image of the product 412 on the display unit 406.

The product database 428, can store a plurality of information on a plurality of products that may be purchased by the user. Further, in order to get access to the plurality of information, the user, may access the product database 428, via the catalog engine 418, as the catalog engine 418 can be configured to extract the plurality of information from the product database 428. The catalog engine 418, may further, store a mapping information comprising a plurality of providers offering a plurality of products, where each provider can be mapped to a set of the plurality of products being offered by that provider. Such mapping information is usually captured, when a provider registers with the system 400. In an event of an update on the plurality of information, being received by a registered provider, the catalog engine 418, can update the plurality of information in the product database 428.

Further, on scanning the visual code 402, of the product 412, the web server 414, shall extract a set of information of the product 412, from the catalog engine 418. The set of information is usually a subset of the mapping information as stored in the catalog engine 418. The set of information shall include information on a set of providers offering the product 412, in and around a location of the portable device 404. Location information indicating the location of the portable device 404, is usually communicated by the portable device 404 to the web server 414. The location information may be retrieved from the network service provider to which the portable device 404, is registered with for communication. A comparator module, can be configured to indicate a provider form the set of providers, that offers a best price of the product 412. The comparator module, in a thin client scenario, usually resides within the web server 414. Alternatively in a thick client scenario, where the portable device 412, contains a large communication bandwidth and higher processing capacity, the comparator module can be deployed on the portable device 404. In the latter scenario, a comparison for the provider offering the best price of the product 412 is performed in the portable device 404. The user may choose to add the product 412, being offered at the best price by the selected provider to a shopping cart 408. Further, information on the added product in the shopping cart 408, maybe sent to the set of providers. The set of providers may in competition, sent one or more updates on the best price of the product. The comparator module can select a second provider, from the one or more of the set of providers, wherein the second provider offers an updated best price of the product. The user may choose to update, by the user interface module 410, the added product with the product as offered by the selected second provider in the shopping cart 408. The catalog engine 418, can store the one or more updates on the best price of the product in the product database 428.

In case, the user, intends to receive feedback reviews on the product 412, from social networking websites 420, 424 and 426, such as Twitter, Facebook, Delicious, YouTube, Flickr, Amazon, Technorati, the user, may signal the web server 414, for receiving feedback information on the product 412, form the social networking engine 416. The social networking engine 416, can fetch a plurality of feedback information from the social networking websites 420, 424 and 426, and provide a feedback on the product 412 to the web server 414. In the disclosed embodiment, the plurality of feedback information can include comments, feedback reviews, and ratings as provided by a selected set of users of the social networking websites. Based on the received feedback, the user may choose to add the product 412 to the shopping cart 408 or delete the product 412 from the shopping cart 408.

The web server 414, can be configured to process a payment of the product 412, on receiving a billing address and a payment information from the user interface module 410. The web server 414, can be further configured to send the billing address of the user to the selected provider, so as to deliver the product 412 to the user at the billing address. Alternatively, the user may choose to get the product 412 delivered instantaneously, at a point of delivery. In the latter case, the web server 414, may receive a time of delivery and a point of delivery of location from the user interface module 410. A payment of the product 412, may be processed by the web server 414, and the time of delivery and the point of delivery location and the payment shall be provided to the selected provider, and the selected provider may deliver the product 412, to the point of delivery location at the time of delivery as specified.

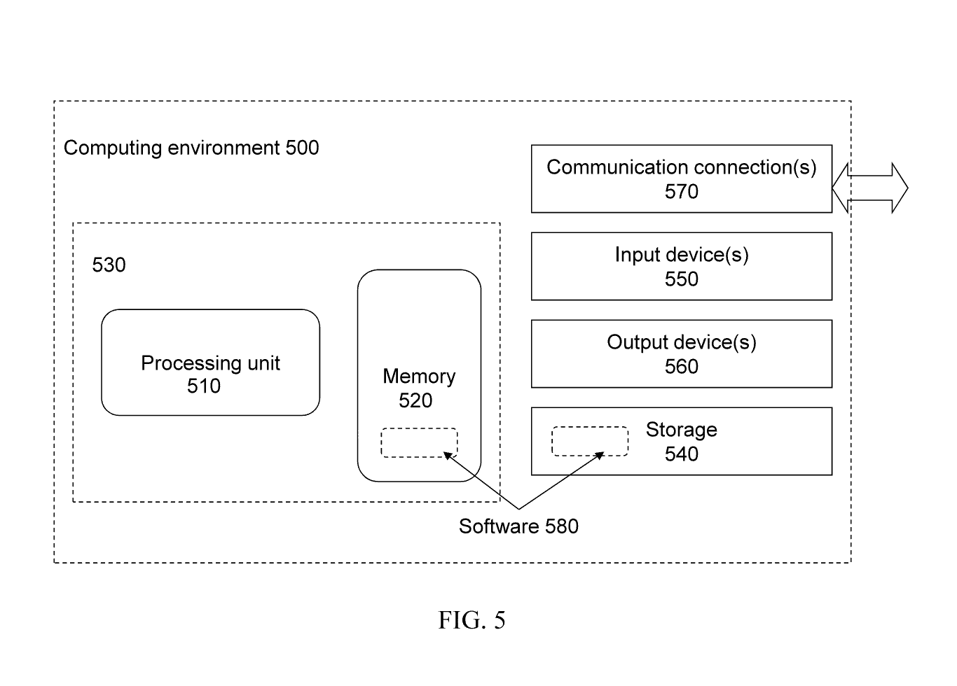

One or more of the above-described techniques can be implemented in or involve one or more computer systems. FIG. 5 illustrates a generalized example of a computing environment 500. The computing environment 500 is not intended to suggest any limitation as to scope of use or functionality of described embodiments.

With reference to FIG. 5, the computing environment 500 includes at least one processing unit 510 and memory 520. In FIG. 5, this most basic configuration 530 is included within a dashed line. The processing unit 510 executes computer-executable instructions and may be a real or a virtual processor. In a multi-processing system, multiple processing units execute computer-executable instructions to increase processing power. The memory 520 may be volatile memory (e.g., registers, cache, RAM), non-volatile memory (e.g., ROM, EEPROM, flash memory, etc.), or some combination of the two. In some embodiments, the memory 520 stores software 580 implementing described techniques.

A computing environment may have additional features. For example, the computing environment 500 includes storage 540, one or more input devices 540, one or more output devices 560, and one or more communication connections 570. An interconnection mechanism (not shown) such as a bus, controller, or network interconnects the components of the computing environment 500. Typically, operating system software (not shown) provides an operating environment for other software executing in the computing environment 500, and coordinates activities of the components of the computing environment 500.

The storage 540 may be removable or non-removable, and includes magnetic disks, magnetic tapes or cassettes, CD-ROMs, CD-RWs, DVDs, or any other medium which can be used to store information and which can be accessed within the computing environment 500. In some embodiments, the storage 540 stores instructions for the software 580.

The input device(s) 550 may be a touch input device such as a keyboard, mouse, pen, trackball, touch screen, or game controller, a voice input device, a scanning device, a digital camera, or another device that provides input to the computing environment 500. The output device(s) 560 may be a display, printer, speaker, or another device that provides output from the computing environment 500.

The communication connection(s) 570 enable communication over a communication medium to another computing entity. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Implementations can be described in the general context of computer-readable media. Computer-readable media are any available media that can be accessed within a computing environment. By way of example, and not limitation, within the computing environment 500, computer-readable media include memory 520, storage 540, communication media, and combinations of any of the above.

Having described and illustrated the principles of our invention with reference to described embodiments, it will be recognized that the described embodiments can be modified in arrangement and detail without departing from such principles. It should be understood that the programs, processes, or methods described herein are not related or limited to any particular type of computing environment, unless indicated otherwise. Various types of general purpose or specialized computing environments may be used with or perform operations in accordance with the teachings described herein. Elements of the described embodiments shown in software may be implemented in hardware and vice versa.

As will be appreciated by those ordinary skilled in the art, the foregoing example, demonstrations, and method steps may be implemented by suitable code on a processor base system, such as general purpose or special purpose computer. It should also be noted that different implementations of the present technique may perform some or all the steps described herein in different orders or substantially concurrently, that is, in parallel. Furthermore, the functions may be implemented in a variety of programming languages. Such code, as will be appreciated by those of ordinary skilled in the art, may be stored or adapted for storage in one or more tangible machine readable media, such as on memory chips, local or remote hard disks, optical disks or other media, which may be accessed by a processor based system to execute the stored code. Note that the tangible media may comprise paper or another suitable medium upon which the instructions are printed. For instance, the instructions may be electronically captured via optical scanning of the paper or other medium, then compiled, interpreted or otherwise processed in a suitable manner if necessary, and then stored in a computer memory.

The following description is presented to enable a person of ordinary skill in the art to make and use the invention and is provided in the context of the requirement for a obtaining a patent. The present description is the best presently-contemplated method for carrying out the present invention. Various modifications to the preferred embodiment will be readily apparent to those skilled in the art and the generic principles of the present invention may be applied to other embodiments, and some features of the present invention may be used without the corresponding use of other features. Accordingly, the present invention is not intended to be limited to the embodiment shown but is to be accorded the widest scope consistent with the principles and features described herein.

While the foregoing has described certain embodiments and the best mode of practicing the invention, it is understood that various implementations, modifications and examples of the subject matter disclosed herein may be made. It is intended by the following claims to cover the various implementations, modifications, and variations that may fall within the scope of the subject matter described.

What is claimed:

1. A method for shopping in an augmented reality, the method comprising:
receiving, by an augmented reality shopping computing device, a visual code of a product from a scanning device;
extracting, by the augmented reality shopping computing device, a set of information of the product from a catalog engine, whereby the set of information comprises a set of providers offering the product within a location of the scanning device;
selecting, by the augmented reality shopping computing device, a provider of the product, wherein the selected provider offers a best price of the product; and
adding, by the augmented reality shopping computing device, the product as offered by the selected provider to a shopping cart.

2. The method of claim 1, further comprising:
receiving, by the augmented reality shopping computing device, a location information of the scanning device, the location information specifying the location of the scanning device.

3. The method of claim 1, further comprising:
receiving, by the augmented reality shopping computing device, a feedback from a social networking engine, wherein the social networking engine fetches a plurality of information on the product from a plurality of social networking websites, when a user of the scanning device chooses to receive the feedback; and
updating, by the augmented reality shopping computing device, the shopping cart, based on the received feedback.

4. The method of claim 3, wherein, the plurality of information comprises at least one or more of comments, feedback, reviews or ratings as provided by a selected set of users of the social networking websites.

5. The method of claim 1, further comprising:
processing, by the augmented reality shopping computing device, a payment for the product;
receiving, by the augmented reality shopping computing device, a billing address and a payment information from the scanning device; and
initiating, by the augmented reality shopping computing device, a delivery of the product to the billing address.

6. The method of claim 1, further comprising:
receiving, by the augmented reality shopping computing device, a time of delivery and a point of delivery location from the scanning device;
processing, by the augmented reality shopping computing device, a payment for the product; and
initiating, by the augmented reality shopping computing device, a delivery of the product to the point of delivery location at the time of delivery.

7. The method of claim 1, wherein the visual code includes one of a QR code or a bar code.

8. The method of claim 1, wherein the set of information is updated by one or more providers periodically.

9. The method of claim 1, further comprising:
sending, by the augmented reality shopping computing device, information on the added product to the set of providers;
receiving, by the augmented reality shopping computing device, from one or more of the set of providers, one or more updates on the best price of the product;
selecting, by the augmented reality shopping computing device, a second provider from the one or more of the set of providers, whereby the second provider offers an updated best price of the product; and
updating, by the augmented reality shopping computing device, the added product with the product as offered by the selected second provider in the shopping cart.

10. The method of claim 1, further comprising:
providing, by augmented reality shopping computing device, a three-dimensional representation of the product.

11. A augmented reality shopping computing device comprising:
a processor coupled to a memory and configured to execute programmed instructions stored in the memory, comprising:
receiving a visual code of a product from a scanning device;
extracting a set of information of the product from a catalog engine, whereby the set of information comprises a set of providers offering the product within a location of the scanning device;
selecting a provider of the product, wherein the selected provider offers a best price of the product; and
adding the product as offered by the selected provider to a shopping cart.

12. The device of claim 11, wherein the processor is further configured to execute programmed instructions stored in the memory further comprising:
receiving a location information of the scanning device, the location information specifying the location of the scanning device.

13. The device of claim 11, wherein the processor is further configured to execute programmed instructions stored in the memory further comprising:
receiving a feedback from a social networking engine, wherein the social networking engine fetches a plurality of information on the product from a plurality of social networking websites, when a user of the scanning device chooses to receive the feedback; and
updating the shopping cart, based on the received feedback.

14. The device of claim 13, wherein, the plurality of feedback information comprises at least one or more of comments, feedback, reviews or ratings as provided by a selected set of users of the social networking websites.

15. The device of claim 11, wherein the processor is further configured to execute programmed instructions stored in the memory further comprising:
processing a payment for the product;
receiving a billing address and a payment information from the scanning device; and
initiating a delivery of the product to the billing address.

16. The device of claim 11, wherein the processor is further configured to execute programmed instructions stored in the memory further comprising:
receiving a time of delivery and a point of delivery location from the scanning device;
processing a payment for the product; and
initiating a delivery of the product to the point of delivery location at the time of delivery.

17. The device of claim 11, wherein the visual code comprises at least one or more of a QR code or a bar code.

18. The device of claim 11, wherein the set of information is updated by one or more providers periodically.

19. The device of claim 11, wherein the processor is further configured to execute programmed instructions stored in the memory further comprising:
sending, by the augmented reality shopping computing device, information on the added product to the set of providers;
receiving, by the augmented reality shopping computing device, from one or more of the set of providers, one or more updates on the best price of the product;
selecting, by the augmented reality shopping computing device, a second provider from the one or more of the set of providers, whereby the second provider offers an updated best price of the product; and
updating, by the augmented reality shopping computing device, the added product with the product as offered by the selected second provider in the shopping cart.

20. The device of claim 11, wherein the processor is further configured to execute programmed instructions stored in the memory further comprising:
providing, by augmented reality shopping computing device, a three-dimensional representation of the product.

21. A non-transitory computer readable medium having stored thereon instructions for shopping in an augmented reality comprising machine executable code which when executed by a processor, causes the processor to perform steps comprising:
receiving a visual code of a product from a scanning device;
extracting a set of information of the product from a catalog engine, whereby the set of information comprises a set of providers offering the product within a location of the scanning device;
selecting a provider of the product, wherein the selected provider offers a best price of the product; and
adding the product as offered by the selected provider to a shopping cart.

22. The medium of claim 21, wherein the medium further comprises machine executable code which, when executed by the processor, causes the processor to perform steps further comprising:
receiving a location information of the scanning device, the location information specifying the location of the scanning device.

23. The medium of claim 21, wherein the medium further comprises machine executable code which, when executed by the processor, causes the processor to perform steps further comprising:
receiving a feedback from a social networking engine, wherein the social networking engine fetches a plurality of information on the product from a plurality of social networking websites, when a user of the scanning device chooses to receive the feedback; and
updating the shopping cart, based on the received feedback.

24. The medium of claim 23, wherein, the plurality of feedback information comprises at least one or more of comments, feedback, reviews or ratings as provided by a selected set of users of the social networking websites.

25. The medium of claim 21, wherein the medium further comprises machine executable code which, when executed by the processor, causes the processor to perform steps further comprising:
processing a payment for the product;
receiving a billing address and a payment information from the scanning device; and
initiating a delivery of the product to the billing address.

26. The medium of claim 21, wherein the medium further comprises machine executable code which, when executed by the processor, causes the processor to perform steps further comprising:
receiving a time of delivery and a point of delivery location from the scanning device;
processing a payment for the product; and
initiating a delivery of the product to the point of delivery location at the time of delivery.

27. The medium of claim 21, wherein the visual code comprises at least one or more of a QR code or a bar code.

28. The medium of claim 21, wherein the set of information is updated by one or more providers periodically.

29. The medium of claim 21, wherein the medium further comprises machine executable code which, when executed by the processor, causes the processor to perform steps further comprising:
sending, by the augmented reality shopping computing device, information on the added product to the set of providers;
receiving, by the augmented reality shopping computing device, from one or more of the set of providers, one or more updates on the best price of the product;
selecting, by the augmented reality shopping computing device, a second provider from the one or more of the set of providers, whereby the second provider offers an updated best price of the product; and
updating, by the augmented reality shopping computing device, the added product with the product as offered by the selected second provider in the shopping cart.

30. The medium of claim 21, wherein the medium further comprises machine executable code which, when executed by the processor, causes the processor to perform steps further comprising:
providing, by augmented reality shopping computing device, a three-dimensional representation of the product.
